(19) United States
(12) Patent Application Publication
(10) Pub. No.: US 2024/0085213 A1
(43) Pub. Date: Mar. 14, 2024

(54) MAP STORAGE DEVICE

(71) Applicant: HITACHI ASTEMO, LTD., Hitachinaka-shi, Ibaraki (JP)

(72) Inventor: Yuichi KOMORIYA, Hitachinaka-shi, Ibaraki (JP)

(73) Assignee: HITACHI ASTEMO, LTD., Hitachinaka-shi, Ibaraki (JP)

(21) Appl. No.: 18/261,911

(22) PCT Filed: Sep. 22, 2021
(86) PCT No.: PCT/JP2021/034771

§ 371 Date: Jul. 18, 2023

(30) Foreign Application Priority Data
Mar. 25, 2021 (JP) 2021-050948

(51) Int. Cl. G01C 21/00

(52) U.S. Cl. CPC G01C 21/3874

(57) ABSTRACT

Provided is a map storage device that generates a map by automatically determining and storing a necessary map without a user's operation. The map storage device includes: a map creation unit that creates map data of a route traveled by a vehicle; a map data temporary storage unit that temporarily stores the map data; a map data storage unit that non-temporarily stores a part of the map data temporarily stored in the map data temporary storage unit; a behavior history information storage unit that stores behavior history information that is a behavior history of the vehicle; and a vehicle behavior determination unit that determines whether or not to store, in the map data storage unit, the map data temporarily stored in the map data temporary storage unit, based on the behavior history information.

### TECHNICAL FIELD

The present invention relates to a map storage device.

### BACKGROUND ART

In order to achieve safe driving, automatic driving, and the like, there is known a technique of estimating a position of a vehicle using an environmental map and information obtained from sensors provided in the vehicle. Conventionally, as a map generation system that generates an environmental map, the known ones are a map generation system that generates a map based on a road surface image from an in-vehicle camera (for example, PTL 1), and a map generation system that generates three-dimensional position information from a distance measured by emitting laser light from a laser range finder and generates a high-precision three-dimensional environmental map (for example, PTL 2). In addition, there is also known a map storage device that stores data stored in a temporary data storage means in a non-temporary storage means only when a vehicle is traveling at a predetermined speed in a case where the vehicle stores the data while traveling (for example, PTL 3).

In map generation systems, when the user arbitrarily generates a map, the user operates a button of a user interface such as a human machine interface (HMI) to instruct the start of map generation and instruct the completion of map generation. In addition, when destination guidance is performed by a navigation system, a section to be stored as a map can be estimated by obtaining information indicating that the vehicle has arrived at a destination from location information registered as the destination.

However, in daily traveling such as commuting from home to workplace or traveling from home to a nearby commercial facility, the user often drives a vehicle without performing daily destination registration or the like, and in this case, a necessary map cannot be stored and generated. In order to store and generate the map, user's operation and information from the outside are needed, which is troublesome for the user who generates the map.

### CITATION LIST

### Patent Literatures

PTL 1: JP 2017-10393 A

PTL 2: JP 2010-66595 A

PTL 3: JP 2001-264074 A

### SUMMARY OF INVENTION

### Technical Problem

The present invention provides a map storage device that generates a map by automatically determining and storing a necessary map without a user's operation.

### Solution to Problem

In order to solve the above problems, a map storage device of the present invention includes: a map creation unit that creates map data of a route traveled by a vehicle; a map data temporary storage unit that temporarily stores the map data; a map data storage unit that non-temporarily stores a part of the map data temporarily stored in the map data temporary storage unit; a behavior history information storage unit that stores behavior history information that is a behavior history of the vehicle; and a vehicle behavior determination unit that determines whether or not to store, in the map data storage unit, the map data temporarily stored in the map data temporary storage unit, based on the behavior history information.

### Advantageous Effects of Invention

The present invention provides a map storage device capable of automatically determining and storing a necessary map without an operation input by a user.

### BRIEF DESCRIPTION OF DRAWINGS

FIG. 1 is a block diagram schematically illustrating an overall configuration of a map storage system according to a first embodiment.

FIG. 2 is a conceptual diagram for explaining backward parking including a turn-back operation of a vehicle detected as a behavior of the vehicle by a vehicle behavior determination unit 103 in the map storage system according to the first embodiment.

FIG. 3 is a flowchart illustrating a map information storage operation according to the first embodiment.

FIG. 4 is a conceptual diagram for explaining forward parking detected as a behavior of a vehicle by a vehicle behavior determination unit 103 in a map storage system according to a second embodiment.

FIG. 5 is a block diagram schematically illustrating an overall configuration of a map storage system according to the second embodiment.

FIG. 6 is a flowchart for explaining an operation of storing map information according to the second embodiment.

FIG. 7 is a conceptual diagram for explaining entry into an intersection detected as a behavior of a vehicle by a vehicle behavior determination unit 103 in a map storage system according to a third embodiment.

FIG. 8 is a block diagram schematically illustrating an overall configuration of a map storage system according to a fourth embodiment.

FIG. 9 is a flowchart illustrating a map information storage operation according to the fourth embodiment.

### DESCRIPTION OF EMBODIMENTS

Hereinafter, the present embodiments will be described with reference to the accompanying drawings. In the accompanying drawings, elements having the same function may be denoted by the same reference numbers. Note that, although the accompanying drawings illustrate embodiments conforming to the principles of the present disclosure, they are for understanding the present disclosure and are not used to interpret the present disclosure in a limited manner. The description herein is exemplary only and is not intended to limit the claims or applications of the disclosure in any way.

In the present embodiment, the description has been made in sufficient detail for those skilled in the art to implement the present disclosure, but it is necessary to understand that other implementations and embodiments are possible, and changes in configurations and structures and replacement of various elements are possible without departing from the scope and spirit of the technical idea of the present disclosure. Therefore, the following description should not be interpreted as being limited thereto.

### First Embodiment

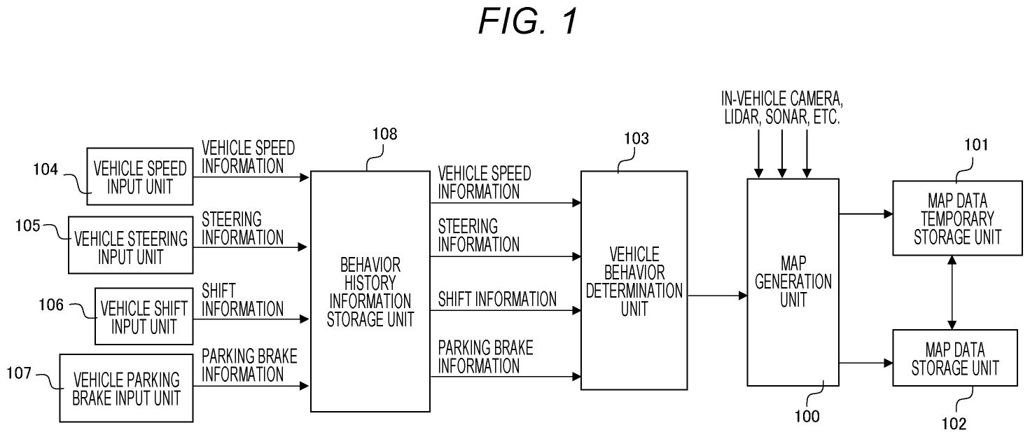

An overall configuration of a map storage system according to a first embodiment will be schematically described with reference to a functional block diagram of FIG. 1. This map storage system is mounted on a vehicle, and includes a map generation unit 100, a map data temporary storage unit 101, and a map data storage unit 102. The map generation unit 100 is configured to be able to communicate with the map data temporary storage unit 101 and the map data storage unit 102 in a wireless or wired manner. The map generation unit 100 has a function of temporarily storing generated map in the map data temporary storage unit 101 and non-temporarily (for a long time or permanently, unless there is an erasure command or the like) storing the map temporarily stored in the map data temporary storage unit 101 under a predetermined condition in the map data storage unit 102.

The map data temporary storage unit 101 is an auxiliary storage configured to temporarily store various data, and includes a semiconductor memory. The map data temporary storage unit 101 is configured to temporarily store map data of a predetermined data amount only for a predetermined period or condition, and appropriately discard the map data at a timing when it is determined that non-temporary storage is unnecessary. The semiconductor memory constituting the map data temporary storage unit 101 may be a volatile memory such as a DRAM, or may be a nonvolatile memory such as a flash memory, an MRAM, or a ReRAM. On the other hand, the map data storage unit 102 is a storage capable of non-temporarily storing various data, and is preferably a hard disk, a flash memory, an MRAM, a CD-RAM, a DVD-RAM, or the like which is a storage device capable of reading and writing a large amount of data and storing data in a nonvolatile manner. Note that the map data storage unit 102 is not necessarily mounted on the vehicle, and may be mounted on a server or the like capable of communicating with the vehicle.

The map generation unit 100 has a function of generating a map from three-dimensional position information and feature points obtained from a distance measuring sensor (not illustrated) such as light detection and ranging (LiDAR) or SONAR. In addition, the map generation unit 100 has a function of generating a map by detecting three-dimensional objects such as signs and traffic lights, figures (paints) on road surfaces such as lanes and crosswalks, and the like from an image or the like captured by an in-vehicle camera (not illustrated). The map generation unit 100 can generate a map by measuring an image obtained in traveling by the vehicle. In addition, the map generation unit 100 has a function of generating a map at all times after the system is started and cyclically storing map data in the map data temporary storage unit 101 as a ring buffer. The amount of the data to be stored in the map data temporary storage unit 101 can be determined according to conditions such as the size of the temporary storage data, the travel distance of the vehicle, and the travel time.

The map generation unit 100 is configured to start storing the map data in the map data storage unit 102 when a predetermined behavior of the mounted vehicle is detected. Therefore, the map storage system includes, as a configuration for determining the behavior of the vehicle, a vehicle behavior determination unit 103, a vehicle speed input unit 104, a vehicle steering input unit 105, a vehicle shift input unit 106, a vehicle parking brake input unit 107, a behavior history information storage unit 108, and the vehicle behavior determination unit 103. Note that, in this specification, the “behavior” of the vehicle is understood in a broad sense including not only a case where the main body of the vehicle is moving but also a case where only a part of the constituent members of the vehicle is performing some operation. The “behavior” mentioned here also includes a case where the vehicle itself is stopped without moving.

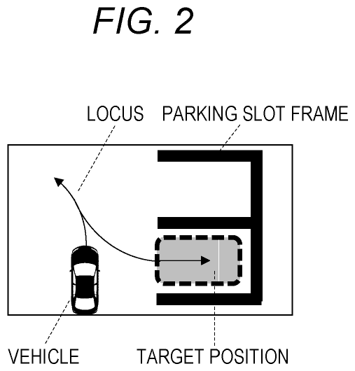

As an example, the vehicle behavior determination unit 103 determines backward parking including a turn-back operation of the vehicle as illustrated in FIG. 2, estimates that the vehicle has arrived at a destination, and instructs the map generation unit 100 to non-temporarily store the map temporarily stored in the map data temporary storage unit 101 to the map data storage unit 102.

The vehicle speed input unit 104 has a function of inputting information (vehicle speed information) related to the speed of the vehicle obtained from a speedometer (not illustrated) or the like mounted on the vehicle. In addition, the vehicle steering input unit 105 inputs information (steering information) related to a steering amount of a steering wheel of the vehicle from a power steering system (not illustrated) or the like. The vehicle shift input unit 106 inputs shift information related to a gear shift of the vehicle from an automatic transmission of an automatic transmission system. The vehicle parking brake input unit 107 inputs parking brake information related to control of a parking brake of the vehicle.

The behavior history information storage unit 108 receives various types of information regarding the behavior of the vehicle from the above-described various input units 104 to 107 over a certain period of time, and stores the information as behavior history information. The vehicle behavior determination unit 103 determines the behavior of the vehicle based on the various pieces of information stored in behavior history information storage unit 108.

Note that the various behavior history information input from the various input units 104 to 107 described above is an example of information for determining the behavior of the vehicle, and needless to say, the various behavior history information is not limited to the combination illustrated in FIG. 1. Input units other than those in FIG. 1 may be additionally employed, or various input units in FIG. 1 may be replaced with other input units. For example, an input unit that inputs information related to the operation of the brake may be additionally employed, or an input unit that inputs sensing information of a sensor that detects opening and closing of a door may be employed. Furthermore, not only information of an operation unit operated by the driver, such as a steering wheel, a brake, and a shift lever, but also a control signal and driving support information from an automatic driving function and a driving support function may be input.

As an example, the behavior history information storage unit 108 starts to store the behavior history information when the vehicle speed from vehicle speed input unit 104 becomes equal to or lower than the threshold. The threshold here can be, for example, 20 km/h. Similarly, various kinds of information from other input units 105 to 107 are started to be stored in behavior history information storage unit 108 when a predetermined condition is satisfied. The plurality of types of behavior history information can be collectively stored in the behavior history information storage unit 108 when conditions for the plurality of types of behavior information are satisfied. Alternatively, when each condition of a plurality of types of behavior information is satisfied, the behavior information may be stored in the behavior history information storage unit 108. The vehicle behavior determination unit 103 determines the behavior of the vehicle from the behavior information stored in the behavior history information storage unit 108 in this manner.

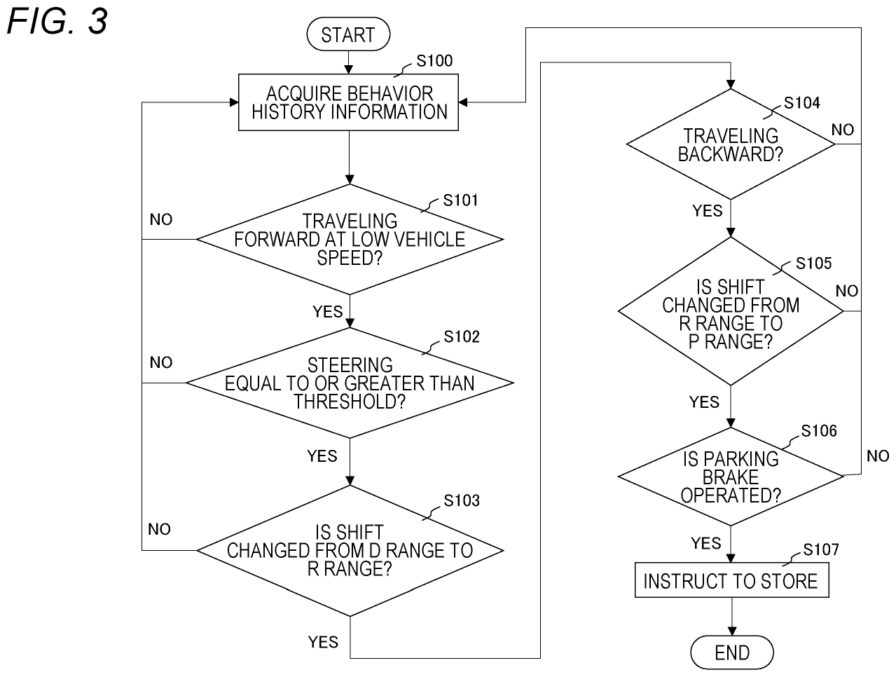

A map information storage operation according to the first embodiment will be described with reference to a flowchart of FIG. 3. Here illustrated is an operation in a case where the vehicle behavior determination unit 103 determines whether or not backward parking is being performed by switching to a back gear and starting backward movement after the vehicle approaches the parking lot at a low speed.

As described above, while the vehicle is traveling, the map generation unit 100 generates map data based on information from an in-vehicle camera, LiDAR, SONAR, or the like, and stores the generated map data in the map data temporary storage unit 101. Meanwhile, when the vehicle speed becomes equal to or lower than a predetermined threshold (for example, 20 km/h), the behavior history information storage unit 108 receives various pieces of behavior history information (vehicle speed information, steering information, shift information, parking brake information) from various input units 104 to 107, and starts to store (acquire) the behavior history information (step S100).

Subsequently, in steps S101 to S106, it is determined whether or not the behavior history information input from the various input units 104 to 107 satisfies a predetermined condition. When a negative determination is made (No) in any of steps S101 to S106, the process returns to step S100, and the same operation is repeated.

In step S101, the vehicle behavior determination unit 103 determines whether the vehicle is traveling forward at a low vehicle speed (for example, 10 km/h or slower) based on the vehicle speed information. When a positive determination is made (Yes) in step S101, the process proceeds to step S102.

In step S102, the vehicle behavior determination unit 103 determines whether or not steering of the steering wheel equal to or greater than the threshold is performed in the vehicle based on the operation information. The threshold here is set to a value for determining whether or not steering of a certain amount or more, which is not performed in normal driving, has been performed in order to cause the vehicle to enter the target position backward. When a positive determination is made (Yes) in step S102, the process proceeds to step S103.

In step S103, the vehicle behavior determination unit 103 determines whether the shift lever has been changed from the “D” range (forward) to the “R” range (backward) in order to move the vehicle backward based on the shift information, and determines whether a turn-back has been performed. When a positive determination is made (Yes), in step S103, the process proceeds to step S104.

In step S104, the vehicle behavior determination unit 103 determines whether the vehicle is traveling backward to park at the target parking position based on the shift information and the vehicle speed information (step S104). When a positive determination is made (Yes) in step S104, the process proceeds to step S105.

In step S105, the vehicle behavior determination unit 103 determines, based on the shift information, whether the shift lever is changed from the “R” range to the “P” range (parking) after the vehicle reaches the target position. When a positive determination is made (Yes) in step S105, the process proceeds to step S106.

In step S106, the vehicle behavior determination unit 103 determines whether the parking brake is operated in the vehicle based on the parking brake information (step S106). When all the determinations in steps S101 to S106 described above are determined to be positive, the vehicle behavior determination unit 103 determines that the vehicle has completed parking at the target parking position, and instructs the map generation unit 100 to transfer the map stored in the map data temporary storage unit 101 to the map data storage unit 102 and store the map (step S107). After completion of the storage operation in the map data storage unit 102, the completion of the storage of the map data around the parking lot may be displayed on a display unit or the like of a navigation system of the vehicle. With this configuration, the user (driver) can recognize that the map data has been saved. Note that, a data erase button may be displayed on the display unit so that the user can instruct to erase the data in a case where the user considers that the map is not needed to be saved. This suppresses wasteful consumption of the capacity of the map data storage unit 102.

Note that, during the backward movement of the vehicle in step S104, when the vehicle cannot be parked at the target position due to approach or contact with a surrounding object, the shift lever may be switched again from the “R” range to the “D” range, the forward travel may be performed again, and then the shift lever may be switched again to the “R” range to restart the backward movement of the vehicle. After the shift lever is switched from the “R” range to the “P” range in step S105, the shift lever may be returned to “R” or “D” again to restart the parking operation. In consideration of this point, the present embodiment is not limited to a case where steps S101 to S106 in FIG. 3 are executed in that order, and it is preferable to determine whether or not some steps are repeated or the same operation is performed again. In addition, when the turn-back operation illustrated in FIG. 2 is completed with a minimum necessary amount, a movement locus may be calculated from speed information and steering information of the vehicle, and the completion of the parking operation may be determined from the movement locus.

As described above, according to the map storage system of the first embodiment, it is determined by the vehicle behavior determination unit 103 that there is a predetermined behavior of the vehicle, and based on the determination result, the map generation unit 100 can non-temporarily store, in the map data storage unit 102, the map data stored in the map data temporary storage unit 101. Therefore, a necessary map can be appropriately stored without depending on user's operation or navigation information.

### Second Embodiment

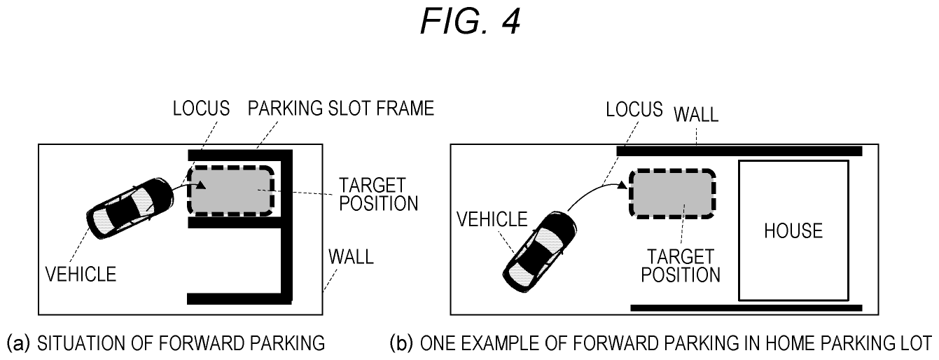

Next, a map storage system according to a second embodiment will be described with reference to FIGS. 4 to 6. As in the first embodiment, in the map storage system of the second embodiment, when the vehicle behavior determination unit 103 determines that the predetermined vehicle behavior has occurred in the vehicle behavior determination unit 103, the map storage system instructs the map generation unit 100 to non-temporarily store, in the map data storage unit 102, the map temporarily stored in the map data temporary storage unit 101. However, the second embodiment is configured to determine whether forward parking of the vehicle has been performed and store map information near a parking position of the forward parking.

FIG. 4 schematically illustrates an example of forward parking. FIG. 4(a) illustrates a situation in which forward parking is performed in a parking lot having a parking frame. FIG. 4(b) illustrates a situation in which forward parking is performed in the home parking lot.

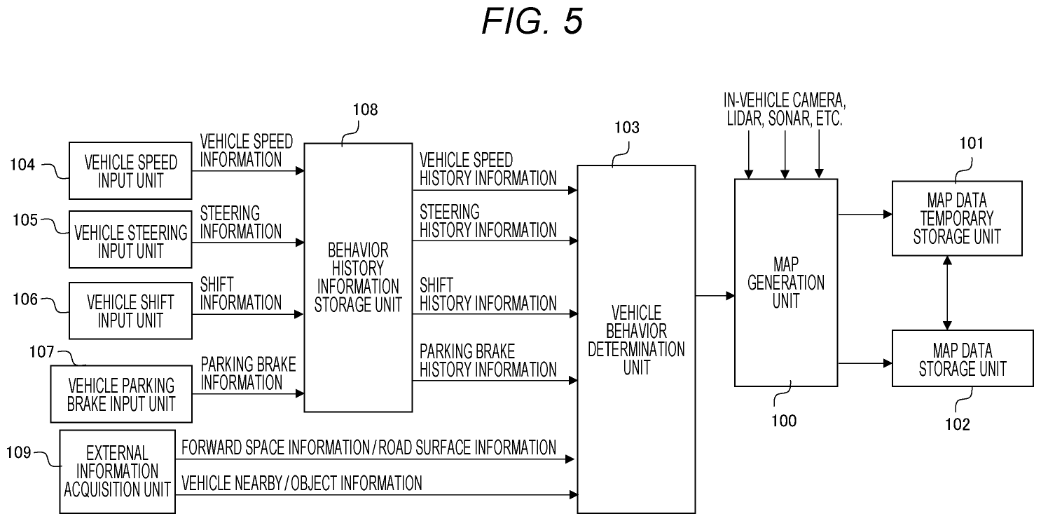

An overall configuration of a map storage system according to a second embodiment will be schematically described with reference to a functional block diagram of FIG. 5. In addition to the components of the first embodiment, the map storage system of the second embodiment further includes an external information acquisition unit 109 that acquires external information, and the vehicle behavior determination unit 103 determines the behavior of the vehicle based on the information acquired by the external information acquisition unit 109 and the behavior history information. The external information acquisition unit 109 is configured to acquire space information in the traveling direction of the vehicle and acquire information regarding the presence or absence of a vehicle around the vehicle.

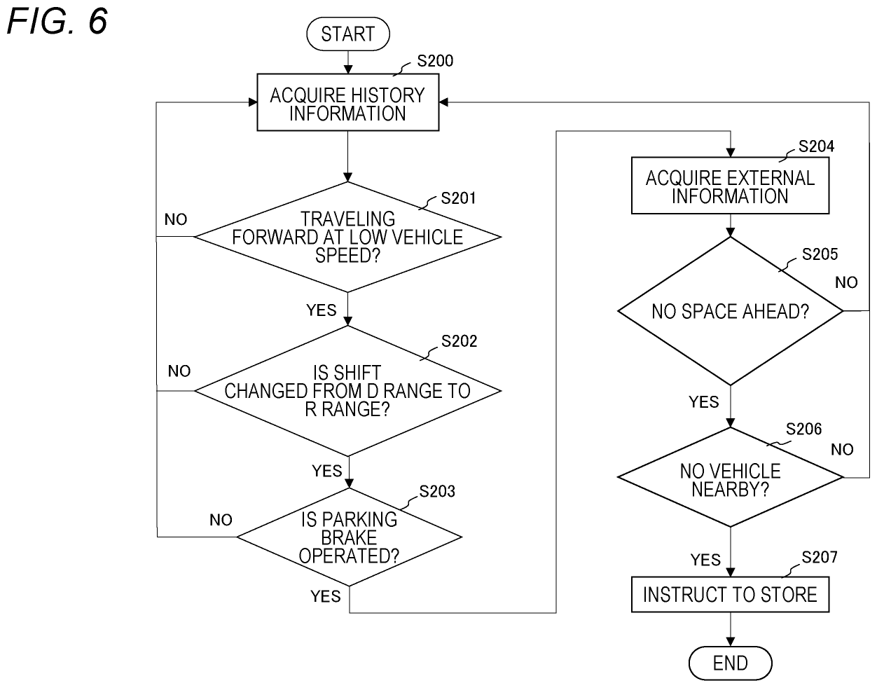

In the forward parking illustrated in FIG. 4, the turn-back is not performed in principle, and thus it is difficult to determine that the vehicle has arrived at the destination by the configuration of the system and the determination method according to the first embodiment. In the map storage system according to the second embodiment, the external information acquisition unit 109 is added to the configuration of the first embodiment, and the determination is performed by the procedure described with reference to FIG. 6, so that it is possible to determine that the vehicle has arrived at the destination even in such forward parking. Then, the map information around the position of the forward parking can be acquired and stored without an instruction from the user.

With reference to the flowchart of FIG. 6, a procedure of an operation of determining that forward parking as illustrated in FIG. 4 has been performed and storing the map information in the second embodiment will be described. This procedure is merely an example, and the present invention is not limited thereto, and it goes without saying that replacement with a similar step, addition of another step, or the like may be appropriately performed.

As in the case of the first embodiment, while the vehicle is traveling, the map generation unit 100 generates map data based on information from the in-vehicle camera, LiDAR, SONAR, or the like, and stores the generated map data in the map data temporary storage unit 101. Meanwhile, when the vehicle speed becomes equal to or lower than a predetermined threshold (for example, 20 km/h), the behavior history information storage unit 108 receives various pieces of behavior history information (vehicle speed information, steering information, shift information, parking brake information) from various input units 104 to 107, and starts to store (acquire) the behavior history information (step S200).

Subsequently, in steps S201 to S206, it is determined whether or not the behavior history information input from the various input units 104 to 107 satisfies a predetermined condition, and it is determined whether or not the situation around the vehicle has reached the predetermined situation based on the information acquired by the external information acquisition unit 109. When a negative determination is made (No) in any of steps S201 to S206, the process returns to step S200, and the same operation is repeated.

In step S201, the vehicle behavior determination unit 103 determines whether the vehicle is moving forward and traveling at a low vehicle speed (for example, 10 km/h or lower) based on the vehicle speed information. When a positive determination is made (Yes) in step S201, the process proceeds to step S202. Note that, before proceeding to step S202, the external information acquisition unit 109 may detect a parking slot frame and determine whether the vehicle has moved to this parking frame.

In step S202, the vehicle behavior determination unit 103 determines whether the shift lever has been changed from the “D” range to the “P” range in order to park the vehicle at the parking position based on the shift information. When a positive determination is made (Yes) in step S202, the process proceeds to step S203.

In step S203, the vehicle behavior determination unit 103 determines whether the parking brake is operated after the vehicle reaches the parking position based on the parking brake information. When a positive determination is made (Yes) in step S203, the process proceeds to step S204.

In step S204, the external information is acquired by the external information acquisition unit 109. Then, in subsequent step S205, it is determined whether or not there is a fence in the space in front of the vehicle and there is no other object based on the external information (step S205). When the positive determination is made (Yes) in step S205, the process proceeds to step S206.

In step S206, it is determined whether or not another vehicle is present around the vehicle based on the external information acquired by the external information acquisition unit 109. When a positive determination is made (Yes) in step S206, the process proceeds to step S207. Note that, in step S206, walls around the vehicle may be detected based on the external information, and it may be determined that the vehicle is in a space surrounded by the walls of the parking lot.

When a positive determination is made (Yes) in step S206, the vehicle behavior determination unit 103 determines that the vehicle has completed parking at the target parking position, and instructs the map generation unit 100 to transfer the map stored in the map data temporary storage unit 101 to the map data storage unit 102 and store the map (step S107).

As described above, according to the map storage system of the second embodiment, as in the first embodiment, the vehicle behavior determination unit 103 determines that there is a predetermined behavior (forward parking) of the vehicle, and according to the determination result, the map generation unit 100 can non-temporarily store the map data stored in the map data temporary storage unit 101 to the map data storage unit 102. Therefore, a necessary map can be appropriately stored without depending on user's operation or navigation information.

### Third Embodiment

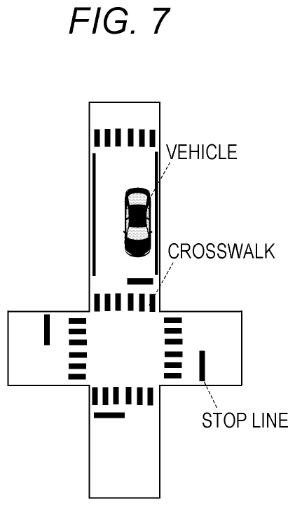

Next, a map storage system according to a third embodiment will be described with reference to FIG. 7. As in the above described embodiments, in the map storage system of the third embodiment, when the vehicle behavior determination unit 103 determines that the predetermined vehicle behavior has occurred in the vehicle behavior determination unit 103, the map storage system instructs the map generation unit 100 to non-temporarily store, in the map data storage unit 102, the map temporarily stored in the map data temporary storage unit 101. However, the map storage system of the third embodiment is configured to determine entry of the vehicle into an intersection as a behavior of the vehicle, transfer map information near the intersection from the map data temporary storage unit 101 to the map data storage unit 102, and non-temporarily store the map information.

The overall configuration of the map storage system of the third embodiment can be in a configuration in which an external information acquisition unit 109 is added to the system of the first embodiment as in the second embodiment (FIG. 5).

According to the third embodiment, when it is detected that the vehicle speed of the vehicle is lower than or equal to a predetermined threshold and the steering amount of the steering wheel of the vehicle is greater than or equal to a predetermined value, the external information acquisition unit 109 acquires images of road side lanes, crosswalks, stop lines, traffic lights, and the like as external information. By determining this image, the vehicle behavior determination unit 103 determines that the vehicle has entered the intersection, and the map data captured and stored around the vehicle can be transferred and stored from the map data temporary storage unit 101 to the map data storage unit 102.

As described above, according to the map storage system of the third embodiment, the vehicle behavior determination unit 103 determines that there is a predetermined behavior of the vehicle (entry to an intersection), and according to the determination result, the map generation unit 100 can non-temporarily store the map data stored in the map data temporary storage unit 101 to the map data storage unit 102. Therefore, a necessary map can be appropriately stored without depending on user's operation or navigation information.

### Fourth Embodiment

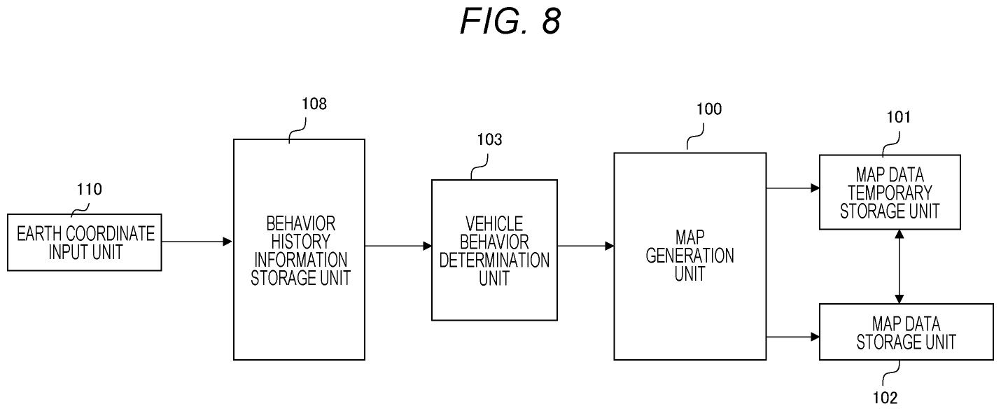

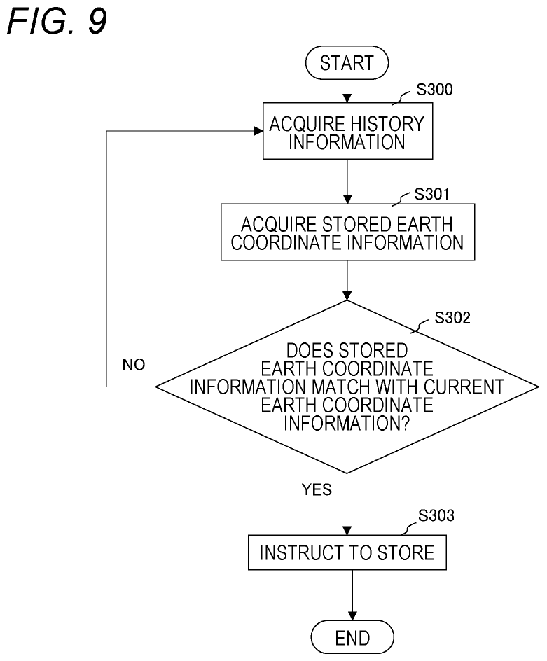

Next, a map storage system according to a fourth embodiment will be described with reference to FIGS. 8 and 9. As in the above described embodiments, in the map storage system of the fourth embodiment, when the vehicle behavior determination unit 103 determines that the predetermined vehicle behavior has occurred in the vehicle behavior determination unit 103, the map storage system instructs the map generation unit 100 to non-temporarily store the map temporarily stored in the map data temporary storage unit 101 in the map data storage unit 102.

However, in the system of the fourth embodiment, as illustrated in FIG. 8, an earth coordinate input unit 110 that acquires coordinate information from a device that detects a position on the earth such as a GPS is connected to the behavior history information storage unit 108. The earth coordinate input unit 110 provides GPS data (coordinate information) as behavior history information, which is different from the above-described embodiments. For example, streets that the vehicle frequently passes is acquired as GPS data, a behavior of the vehicle is determined according to the GPS data, and whether or not to store a map is determined.

The behavior history information storage unit 108 appropriately stores the coordinate information including the past coordinate information input from the earth coordinate input unit 110, and the vehicle behavior determination unit 103 determines whether the past coordinate information and the current coordinate information are similar, and instructs the map generation unit 100 to non-temporarily store the data stored in the map data temporary storage unit 101 to the map data storage unit 102 according to the determination result. As an example, the vehicle behavior determination unit 103 can determine that the past coordinate information and the current coordinate information are the same when the same coordinate information is obtained over a predetermined range or more for the threshold number of times (for example, three times) or more.

With reference to the flowchart of FIG. 9, an operation procedure for determining whether a street is a frequently used street and storing the map information in the fourth embodiment will be described. This procedure is merely an example, and the present invention is not limited thereto, and it goes without saying that replacement with a similar step, addition of another step, or the like may be appropriately performed.

As in the case of the above described embodiments, while the vehicle is traveling, the map generation unit 100 generates map data based on information from the in-vehicle camera, LiDAR, SONAR, or the like, and stores the generated map data in the map data temporary storage unit 101. Meanwhile, the behavior history information storage unit 108 appropriately acquires the current coordinate information of the vehicle from the earth coordinate input unit 110 (step S300).

When the current coordinate information is obtained by the predetermined information amount or more, the vehicle behavior determination unit 103 acquires the past coordinate information stored in the behavior history information storage unit 108 (step S301), and determines whether a matching degree between the stored coordinate information and the current coordinate information is a predetermined threshold value or more, and whether matching has been confirmed a plurality of times at the same position in the past (step S302). When a positive determination is made (Yes), the vehicle behavior determination unit 103 determines that the position is a frequently passed position (a street or the like), and instructs the map generation unit 100 to transfer the map stored in the map data temporary storage unit 101 to the map data storage unit 102 and store the map (step S303).

As described above, according to the fourth embodiment, the vehicle behavior determination unit 103 determines that there is a predetermined behavior of the vehicle (that the vehicle has passed through a street that the vehicle frequently passes), and according to the determination result, the map generation unit 100 can non-temporarily store the map data stored in the map data temporary storage unit 101 to the map data storage unit 102. Therefore, a necessary map can be appropriately stored without depending on user's operation or navigation information.

The present disclosure is not limited to the above-described embodiments, and includes various modifications. For example, the above embodiments have been described in detail to explain the present disclosure clearly, and all the described configurations do not have to be included. Further, a part of one embodiment can be replaced with a configuration of another embodiment. Furthermore, the configuration of another embodiment can be added to the configuration of one embodiment. Furthermore, for a part of the configuration of each embodiment, a part of the configuration of another embodiment can be added, deleted, or replaced.

### REFERENCE SIGNS LIST

100 map generation unit
101 map data temporary storage unit
102 map data storage unit
103 vehicle behavior determination unit
104 vehicle speed input unit
105 vehicle steering input unit
106 vehicle shift input unit
107 vehicle parking brake input unit
108 behavior history information storage unit
109 external information acquisition unit
110 earth coordinate input unit

1. A map storage device, comprising:
a map creation unit that creates map data of a route traveled by a vehicle;
a map data temporary storage unit that temporarily stores the map data;
a map data storage unit that non-temporarily stores a part of the map data temporarily stored in the map data temporary storage unit;
a behavior history information storage unit that stores behavior history information that is a behavior history of the vehicle; and
a vehicle behavior determination unit that determines whether or not to store, in the map data storage unit, the map data temporarily stored in the map data temporary storage unit, based on the behavior history information.

2. The map storage device according to claim 1, wherein when speed of the vehicle becomes equal to or lower than a threshold value, the behavior history information storage unit starts to store the behavior history information.

3. The map storage device according to claim 1, wherein the vehicle behavior determination unit is configured to determine, based on an operation of a shift lever of the vehicle, whether or not the vehicle is performing a predetermined action.

4. The map storage device according to claim 3, wherein the vehicle behavior determination unit is configured to determine, based on the vehicle speed and a steering amount of a steering wheel, whether or not the vehicle is performing a predetermined action.

5. The map storage device according to claim 4, wherein the vehicle behavior determination unit is configured to determine, based on operation information of a parking brake of the vehicle, whether or not the vehicle is performing a predetermined action.

6. The map storage device according to claim 1, further comprising
an external information acquisition unit that acquires external information that is surrounding information of the vehicle,
wherein the vehicle behavior determination unit determines whether or not to store, in the map data storage unit, the map data temporarily stored in the map data temporary storage unit, based on the external information and the behavior history information.

7. The map storage device according to claim 6, wherein the external information acquisition unit is configured to acquire surrounding information of the vehicle when the vehicle is stopped.

8. The map storage device according to claim 6, wherein the external information acquisition unit is configured to acquire information related to a driving lane on a road surface where the vehicle is traveling and a road surface indication.

9. The map storage device according to claim 1, further comprising
an earth coordinate input unit that acquires earth coordinate information of the vehicle,
wherein the behavior history information storage unit is configured to store the coordinate information.
